(19) United States
(12) Patent Application Publication
(10) Pub. No.: US 2013/0110681 A1
(43) Pub. Date: May 2, 2013

(54) APPARATUS, SYSTEM AND METHOD FOR BARTERING

(71) Applicant: Steelberg Ryan, Newport, CA (US)

(72) Inventor: Steelberg Ryan, Newport, CA (US)

(21) Appl. No.: 13/660,578

(22) Filed: Oct. 25, 2012

Related U.S. Application Data
(60) Provisional application No. 61/551,228, filed on Oct. 25, 2011.

(51) Int. Cl. G06Q 30/06

(52) U.S. Cl. CPC G06Q 30/0601
USPC 705/27.1

(57) ABSTRACT

The present invention is and includes a device, system and method for providing a bartering marketplace wherein users may offer for sale or barter items and/or services, such as, for example, luxury goods, event tickets, and professional services.

### CROSS-REFERENCE TO RELATED APPLICATION

This application claims priority to U.S. Provisional Patent Application Serial No. 61/551,228, filed Oct. 25, 2011, entitled Apparatus, System, and Method for Bartering, the entirety of which is expressly incorporated herein by reference in its entirety.

### BACKGROUND OF THE INVENTION

1. Field of the Invention

The present invention is directed to a marketplace for the exchanging of goods and services and, more particularly, to an apparatus, system and method for the bartering of goods and services.

2. Description of the Background

Bartering as a form of marketplace transaction has been around for centuries. The exchange of goods at a perceived value is often the most efficient transaction between two parties. Bartering, of course, may include the exchange of goods and/or services, and may further include the exchange of a combination of goods and services. For example, a doctor may exchange medical assistance for the receipt of home repair services.

The bartering of goods and services generally happens in the absence of any cash consideration, but may include currency as at least an aspect of the exchange.

A classic bartering transaction may include at least the inspection or evaluation of the goods and services offered in the transaction. In a traditional barter transaction, inspection or evaluation, of the goods is usually done firsthand by the provider or receiver of the bartered item. For example, in the exchange of goods, each party would have the opportunity to visually inspect the goods and have the ability to evaluate the value each side of the transaction, thus consummating a near perfect meeting of the minds.

However, in today's society, barter transactions are often consummated remotely from the provider and/or receiver of the good or service. In addition, the bartered item may be remote from either party and difficult to value or assess. Without the means to properly assess or value either side of the barter transaction, such transaction may lack a meeting of the minds and may result in at least one party feeling at best unsatisfied with the transaction.

Thus, the need exists for an apparatus, system and method to allow for providing to both parties in the transaction the information necessary to properly evaluate and value the goods/services being offered in the transaction.

### BRIEF DESCRIPTION OF THE DRAWINGS

Understanding of the disclosure will be facilitated by consideration of the following detailed description of the embodiments, taken in conjunction with the accompanying drawings, in which like numerals refer to like parts and in which:

FIG. 1 is a block diagram that illustrates the system of engines in accordance with the present invention;

FIG. 2 is a block diagram that illustrates a network structure in accordance with the present invention;

FIG. 3 is a diagram illustrating a communication structure of the present invention; and

FIG. 4 is a diagram illustrating a communication structure of the present invention.

### DETAILED DESCRIPTION OF THE INVENTION

It is to be understood that the figures and descriptions of the present invention have been simplified to illustrate elements that are relevant for a clear understanding of the present invention, while eliminating, for the purposes of clarity, many other elements found in typical electronic transmission apparatuses, systems and methods. Those of ordinary skill in the art will recognize that other elements are desirable and/or required in order to implement the present invention. However, because such elements are well known in the art, and because they do not facilitate a better understanding of the present invention, a discussion of such elements is not provided herein.

The present invention may facilitate marketplace transactions involving the buying and selling of goods, and/or specifically the bartering of goods and/or services, between at least two parties. More specifically, the present invention allows for the verification and/or certification of the value of the good or service by either party in the transaction.

In an embodiment of the present invention, a person wishing to offer an asset or barter may submit the asset to the present invention via a GUI discussed further herein. The information entered about the asset may be assigned an identifier to correlate the asset with the person offering the asset, which information may be stored in a system-assessable database or vault. Such information may then be accessible by a verification engine which may facilitate the valuation and verification of the asset.

Once an asset has been verified and/or valued, the asset may be assigned a dollar amount or dollar value normalized against other assets within the system that are offered for barter in the system. Once valued and normalized, the asset may be categorized within the system by identifying whether the bartered asset offered is an asset or service, is tangible or intangible, and/or fundable or persistent, for example. The asset may also have attributes assigned thereto which may not have otherwise been included in the offer or by the offeror of the bartered item, such as, for example, the temporal nature of the offer(s) or asset(s), geographic location of the asset, the asset's overall availability, and/or other specific terms, such as, for example, government licenses or visas required, citizenship requirements, age and gender qualification and/or licensing requirements. As used herein, “offeror”, “offeree”, user, agent, and/or representative may be used interchangeably and indicates at least some participation with the present invention.

In an embodiment of the present invention, offers made within the system may be normalized based on the offering itself, as well as the any counter-offer made in lieu of acceptance. For example, a vacation house may be offered for use at a certain price per week and a “bidder” for a certain week of use may offer something else other than cash, such as, for example, a week of use of a vacation home in a different location or professional services, such as accounting work, in lieu of cash payment. Each side of the presented bargain may be normalized to present to each side of the transaction a “cash” equivalent value of each non-cash offer.

By way of non-limiting example only, a non-cash offer/offering may be valued by the present invention by correlating data both within the system and available third party information. Internal information may be accumulated over time and may include values created by the present invention, set by an offeror, and/or offered by an offeree. This information, in association with attributes of the offered assets, may allow for the approximation of a cash value. Similarly, normalization may take into account information from third party sources, such as hourly rates for certain professional services and the offered cash price for other advertised tangibles, for example.

A calculated cash price may further by influenced by additional factors relating to the offered asset. These “external” factors may be temporal in nature and may be calculated in real-time. For example, the cash equivalence for the use of a beach house in South Carolina may be discounted in real-time if, for example, a hurricane is projected to strike the area of the home during and/or within a certain time of the offered time. Similarly, the cash equivalent value of use of a private jet may be increased based on a spike in fuel costs (not otherwise passed on as a condition of acceptance of the offer). Such information may be housed in a database communicatively connected to a normalization engine for performing the normalization actions described herein.

In an embodiment of the present invention, the valuation of an asset may be presented as points, wherein such points are assigned in relation to the value of the asset offered. For example, 10 hours of tax advice from an attorney may be assigned a point value of 5 while a one week stay at a villa in Southern France may be assigned a value of 60 points. Although barters of varying value may be consummated, a points system may allow for a user to more easily assess the equity of the proposed barter. Furthermore, the assets offered by an accepted or authorized member of the marketplace may similarly restricted to having at least a threshold value such as, for example, a value of at least one-thousand dollars.

Access to the marketplace provided by the present invention may be limited to authorized individuals. Such authorization and/or limitations on membership or participation within the marketplace may be dependent upon the social and/or economic status of a prospective member, for example. The present invention may automatically assess a member based on referrals from other members and may further conduct a verification of the net-worth of the individual through a query of known assets held by the prospective member. Such a query by the present invention may include accessing 10-K records IRS filings and/or bank records, for example. Similarly, a potential member of the marketplace may be evaluated through personal interview and/or a review of requested documents sent by the potential member.

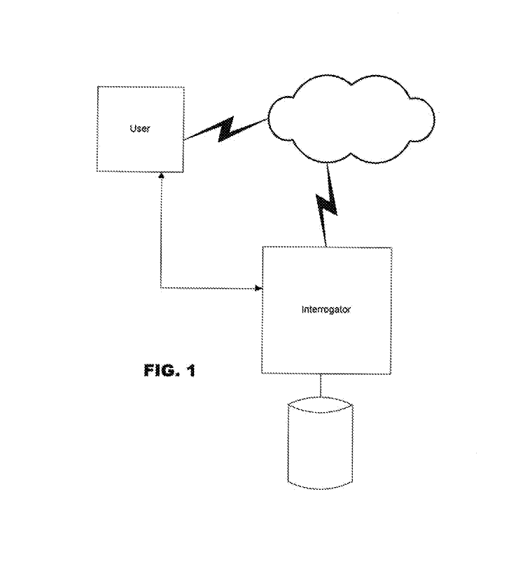

In addition to providing details regarding individual assets offered into the marketplace, the present invention may further allow individuals to be themselves characterized as assets and may further search out other assets held by the member. As illustrated in FIG. 1, an interrogator and/or web-crawler may access information regarding a member from a system database and may search 3^{rd} party websites for assets which may be owned by the member (owned and/or controlled). Such 3^{rd} party websites may include, for example, eBAY® Angie's List®, CraigsList®, Stubhub®,, home rental websites, an MLS® listing and/or like websites which may allow for the offering of assets to the purchase and/or rented.

Unless specifically stated otherwise, the use of terms such as “processing”, “computing”, “calculating”, “determining”, “displaying” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

A computer readable medium may include any mechanism for storing or transmitting information in a form readable by a machine (e.g., a computer). For example, a machine-readable medium includes a machine readable storage medium (e.g., read only memory (“ROM”), random access memory (“RAM”), magnetic disk storage media, optical storage media, flash memory devices, etc.), a machine readable transmission medium (electrical, optical, acoustical or other form of propagated signals (e.g., carrier waves, infrared signals, digital signals, etc.)), etc.

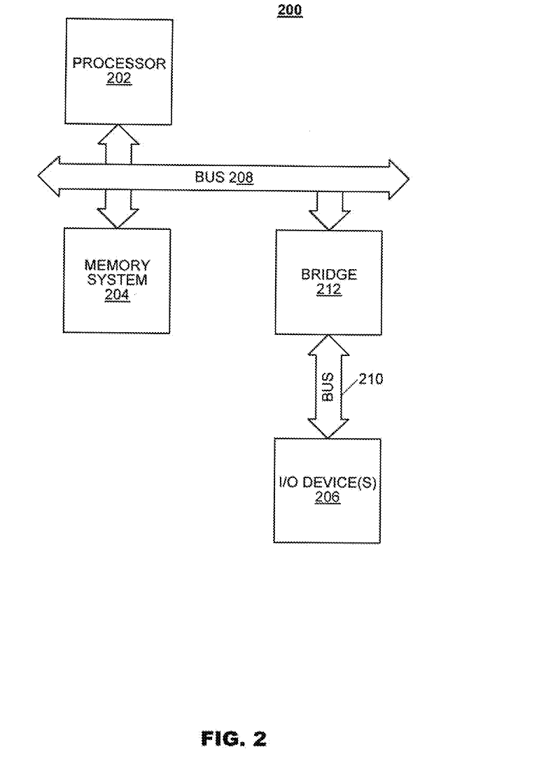

FIG. 2 is an example of a simplified functional block diagram of a computer system 200. The functional descriptions of the present invention can be implemented in hardware, software or some combination thereof. For example, a valuation engine and a verification engine of the present invention can be implemented using a computer system.

As shown in FIG. 2, the computer system 200 includes a processor 202, a memory system 204 and one or more input/output (I/O) devices 206 in communication by a communication ‘fabric’. The communication fabric can be implemented in a variety of ways and may include one or more computer buses 208, 210 and/or bridge and/or router devices 212 as shown in FIG. 2, The I/O devices 206 can include network adapters and/or mass storage devices from which the computer system 200 can send and receive data for generating and transmitting advertisements with endorsements and associated news. The computer system 200 may be in communication with the Internet via the I/O devices 208.

The various illustrative logics, logical blocks, modules, and engines, described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of instructions on a machine readable medium and/or computer readable medium,

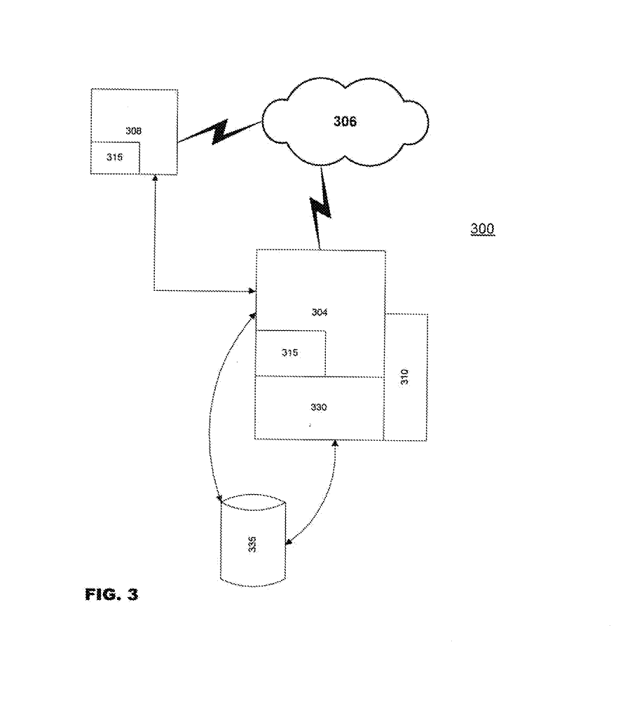

FIG. 3 illustrates an exemplary network architecture 300, in which embodiments of the present invention may operate. The network architecture 300 may include a client device (client) 308, a server 304, an anonymous proxy 310 and a network 306. The client 308, the server 304 and the anonymous proxy 310 may be coupled to the network 306, which may be a public network (e.g., Internet) or a private network (e.g., Ethernet or a local area Network (LAN)), for example.

In one embodiment, the server 304 is a web server that provides text, images and other information in the form of one or more web pages 315. The server 304 may accept user requests for content (e.g., hyper text transfer protocol (HTTP) requests) from client 308, and reply by sending responses (e.g., HTTP responses) which may include information pertaining to member offerings 315.

The client 308 may be, for example, a personal computer (PC), mobile phone, palm-sized computing device personal digital assistant (PDA), etc. The client 308 may include a browser 325, The browser 325 is an application that enables the client 308 to display and interact with the GUI provided by the server 304. In an embodiment, the browser 325 is a web browser configured to display web pages 315.

Browser 325 may receive user requests for content, such as offerings made by other users, and send such a request to server 304. In an embodiment of the present invention, a user request for content is sent to the server 304 to access one or more member offerings 315. As described above, offerings may also be directed to normalization engine 330 and/or to database 335. User requests for content may also be sent to the server 304 to initiate some function, such as, for example, a request for content may be sent to the server 304 to initiate a search function to obtain a listing of available member offerings which may be accessible in database 335, for example.

Whenever a user request for offerings is sent to the server 304, that request may include user identifying information. User identifying information is information that may be used to track user browsing/search behavior, to determine user preferences, and to facilitate the providing of targeted advertising and/or offers to the user. Examples of user identifying information include an IP address, cookies, and the member information collected during the verification and authorization process. User identifying information may also provide a system user with other users' contact information and/or information regarding special events and/or other networking opportunities. As would be appreciated by those skilled in the art, the present invention may also include a user accessible blog, discussion board, internal email, or like communication means to facilitate inter-user communications.

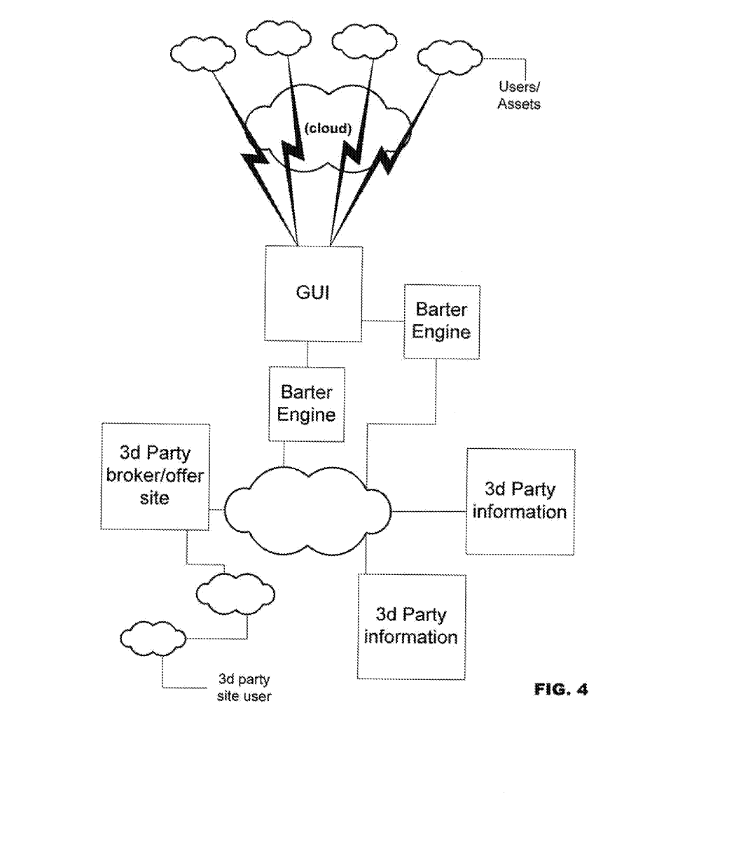

The foregoing and the discussion below may be illustrated with respect to FIG. 4. Such user indentifying information may be employed in conjunction with each side of an asset offering. For example, a user of the present invention may have rights in a dugout suite at Angel Stadium with the face value for all 12 seats being $2500 per game, and may wish to offer such an asset for barter. Such an asset may be submitted on a seat-by-seat per game basis for a specific date, such as September 27^{th}, for example. This offered item may then be brought to the attention of all users and may be specifically and/or more prominently brought to the attention of users who's attributes indicate a desire to see a baseball game in Southern California, for example. Similarly, the offeror of the game may be presented with other user initiated offers within the system that may match the offeror's attributes.

A “best match” may be when two users are offering what the each of the other user has indicated is a highly desired asset. Continuing with the above example, the user offering the game tickets may have indicated in a user profile or through a search of the system that the use of a yacht during the Cannes Film Festival is desired. In such an instance, the present invention may match and alert these users to allow for a possible transaction to consummate. If after some predetermined period of time, such, as 24 hours, for example, the two parties do not engage each other, then the offered asset may be presented to additional users. Such an offer may also be made outside of the system users through such services as EBay and StubHub, for example. Such a transaction may be controlled by the user and may not avail a party accessing the offer through such a third system interface access to the present invention.

In an embodiment of the present invention, the system may also solicit potential “barter fits” from the users of the system based upon, for example, available asset(s) and the owner/controller of asset (which may be inclusive of the offeror). In this way, the system may efficiently complete transactions by offering certain assets in a targeted manner based on at least one user attribute as discussed above. For example, if a user often seeks professional services as part of the barter, the system may target offers of professional services to the user and may similarly alert the offer of services to the goods the have been or are offered by such user of services.

As described in part above, the present invention may also utilize third party sites to effectuate and/or “advertise” barter opportunities such as through eBAY®, Angie's List®, CraigsList®, Stubhub®, for example. Similar to the best “fit” described above, the present invention may assess the asset in light of owner/controller of asset, and owner/controller attributes and desired opportunities and may present/solicit barter opportunities to such an owner/controller.

For example, an owner/controller may be a celebrity or professional shopper, and/or curator and may be influenced and/or looking to barter with like or a specific category of user. For example, celebrities may wish to only deal with other celebrities. Similarly, a personal shopper may wish to have dealings with a celebrity to provide social interaction between the personal shopper and the celebrity. In this way, the present invention may be a useful tool for not only directed advertising based on user information, but a social introduction tool which may be used by a user to target certain other users.

Although the invention has been described and pictured in an exemplary form with a certain degree of particularity, it is understood that the present disclosure of the exemplary form has been made by way of example, and that numerous changes in the details of construction and combination and arrangement of parts and steps may be made without departing from the spirit and scope of the invention.

What is claimed is:

1. A system for the virtual bartering of goods or services, comprising:
a non-transitory computer readable storage medium having encoded thereon computer executable instructions for providing a graphical user interface capable of locally querying at least one user for the input of user identifying information;
at least one remote database capable of receiving user identifying information from a plurality of users and at least two user requests; and
at least one server communicatively connected to the at least one remote database capable of matching at least one user request to at least one of the plurality of users in accordance with user identifying information;
wherein at least one of the at least two user requests comprises an good or service.

2. The system of claim 1, wherein the at least one user request includes a sports commodity.

3. The system of claim 1, wherein the at least one user request includes real estate.

4. The system of claim 1, wherein the user identifying information includes a value indicator correspondent to a user request.

5. The system of claim 1, wherein the at least one user request comprises a sports commodity.

6. The system of claim 1, wherein the at least one server is capable of matching at least one user request to at least one asset offered by at least one third party.
